(19) United States
(12) Patent Application Publication
(10) Pub. No.: US 2007/0039672 A1
(43) Pub. Date: Feb. 22, 2007

(54) Tire with protection protrusions encompassing discharge terminals

(76) Inventor: Tsai Jen Lo, Changhwa Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/204,312

(22) Filed: Aug. 16, 2005

(51) Int. Cl. B60C 19/08

(52) U.S. Cl. 152/152.1; 152/209.5

(57) ABSTRACT

A tire includes a tread rubber layer, a conductive layer located beneath the tread rubber layer and a reinforcement layer located at side periphery of the tread rubber layer and the conductive layer. Tread grooves are defined in a top surface of the tread tuber layer and a protection protrusion extends along each top edge of the tread grooves and protrudes beyond the top surface of the tread rubber layer. The conductive layer has at least one discharge terminal which is connected to an inner periphery of the tread groove. The at leas tone discharge terminal is exposed after the protection protrusions are worn out.

### FIELD OF THE INVENTION

The present invention relates to a tire having discharge terminals and protection protrusions protrude from the tread surface and encompass the discharge terminals.

### BACKGROUND OF THE INVENTION

A conventional tire 80 with discharge terminals is shown in FIG. 4 and generally includes a rubber layer 81 and a fiber layer 82 which is located beneath the rubber layer 81 and a plurality of metal wires and non-woven fabrics (not shown) are disposed to the sidewalls of the tire to support the contour of the tire 80. A conductive layer 85 made by conductive rubber is disposed between the rubber 81 and the fabric layer 82. The conductive layer 85 includes a plurality of discharge terminals 86 toward the tread surface of the tire 80 and the respective distal ends of the discharge terminals 86 are exposed to the tread surface of the tire 80 so as to be in contact with the ground to release statistic electricity to the earth.

It is noted that all the discharge terminals 86 are disposed in the tread surface which is located the thickest part of the rubber layer 81 of the tire 80. Therefore, it requires a longer time of treatment for compressing the tire 80 and more energy during the manufacturing processes. This increases manufacturing cost for the tires 80. Besides, before the tires 80 are used to vehicles, the discharge terminals 86 are exposed so that they actually discharge statistic electricity when the tires 80 are piled in stock. This could be harmful to the people.

The present invention intends to provide a tire that includes protection protrusions protruding from the tread surface of the tire and the terminal discharge terminals are engaged with the tread grooves and encompass by the protection protrusions so that the discharge terminals are not in contact with foreign parts before the protection protrusions are worn out.

### SUMMARY OF THE INVENTION

The present invention relates to a tire that includes a tread rubber layer, a conductive layer located beneath the tread rubber layer and a reinforcement layer which is located at side periphery of the tread rubber layer and the conductive layer. Tread grooves are defined in a top of the tread tuber layer. The green tire is proceeded by step of curing built to form a tire and a protection protrusion extends along each top edge of the tread grooves and protrudes beyond the top of the tread rubber layer. The conductive layer located beneath the tread rubber layer has at least one discharge terminal which is connected to an inner periphery of the tread groove and encompassed by the protection protrusions.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is an exploded view to show two conductive members and a green tire of the present invention;

FIG. 2 shows that the two conductive members are engaged with the tread grooves of the green tire;

FIG. 3 is a cross sectional view to show the wedge-shaped discharge terminals are formed in the tread grooves, and

FIG. 4 shows a conventional tire with discharge terminals.

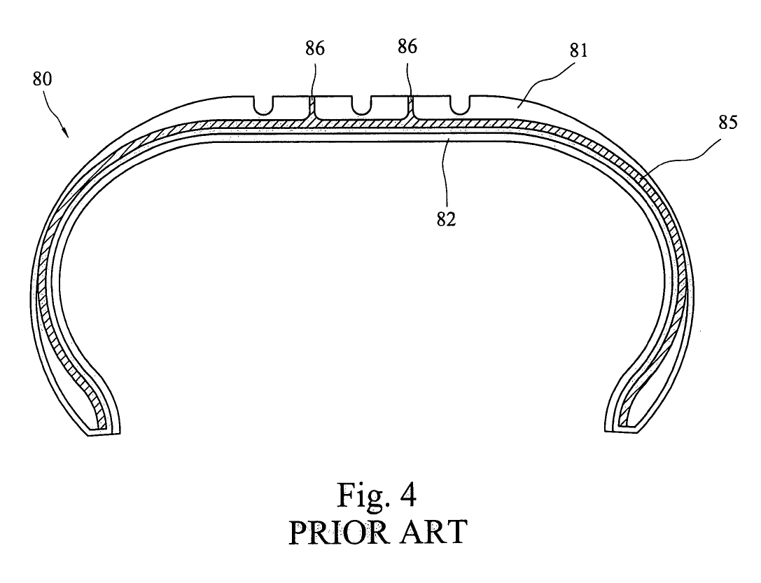

### DETAILED DESCRIPTION OF THE PREFERRED EMBODIMENT

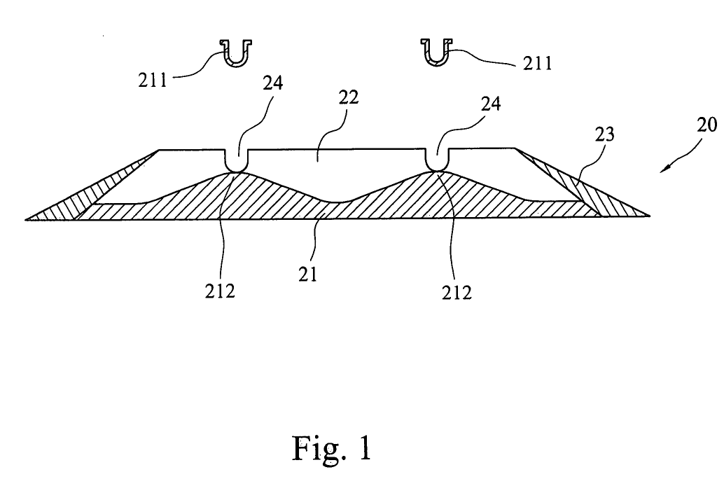

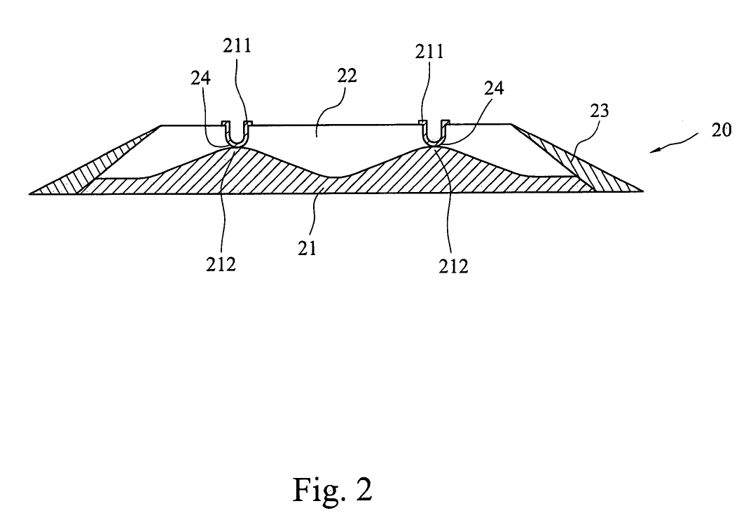

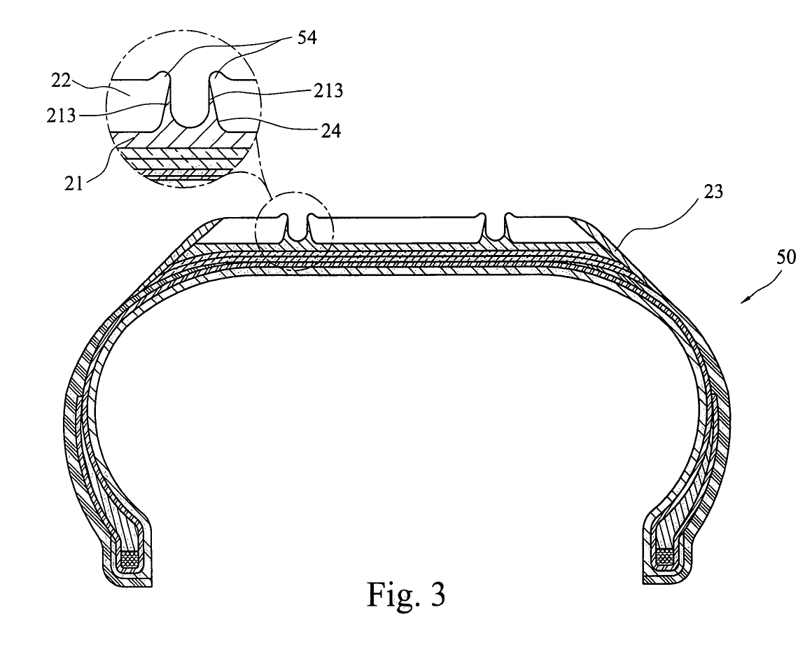

Referring to FIGS. 1 to 3, the green tire 20 of the present invention comprises a tread rubber layer 22, a conductive layer 21 located beneath the tread rubber layer 22 and a reinforcement layer 23 which is located at side periphery of the tread rubber layer 22 and the conductive layer 21. The conductive layer 21 includes a plurality of conductive convexes 212 which are located corresponding to the tread grooves 24 defined in a top of the tread rubber layer 22. A conductive member 211 is inserted in each of the tread grooves 24.

The green tire 20 is then proceeded by step of curing built to form a tire 50 with desired tread and the conductive convexes 212 are combined with the conductive members 211 to form discharge terminals 213 which extend from the conductive layer 21 and are connected to an inner periphery of the tread groove 24.

A protection protrusion 43 extends along each top edge of the tread grooves 24 and protrudes from the top of the tread rubber layer 22. The discharge terminals 213 each include a wedge-shaped cross section which is encompassed by the protection protrusions 54 so that the discharge terminals 213 are not exposed when the tire 50 is not yet used. In other words, when the tires 50 are piled up, the discharge terminals 213 do not contact any foreign objects.

After the tires 50 are used, the protection protrusions 54 are worn out so that the discharge terminals 213 are exposed and in contact with the ground.

The conductive convexes 211 are located at the thinner area where the tread grooves 24 are defined, in other words, less conductive rubber and energy are needed when proceeding step of curing built the conductive convexes 211 of the tread rubber layer 22.

While we have shown and described the embodiment in accordance with the present invention, it should be clear to those skilled in the art that further embodiments may be made without departing from the scope of the present invention.

What is claimed is:

1. A green tire comprising:
a tread rubber layer, a conductive layer located beneath the tread rubber layer and a reinforcement layer which is located at side periphery of the tread rubber layer and the conductive layer , tread grooves defined in the tread tuber layer , the conductive layer including at least one conductive convex which is located corresponding to one of the tread grooves , and
a conductive member received in each of the tread grooves and combined with the conductive member to form a discharge terminal after the green tire is treated by step of curing built.

2. A tire comprising:
a tread rubber layer, a conductive layer located beneath the tread rubber layer and a reinforcement layer which is located at side periphery of the tread rubber layer and the conductive layer, tread grooves defined in the tread tuber layer;
a protection protrusion extending along each top edge of the tread grooves and protruding beyond a top of the tread rubber layer, and
the conductive layer having at least one discharge terminal which extends from the conductive layer and is connected to an inner periphery of the tread groove, the at least one discharge terminal being encompassed by the protection protrusions.

3. The tire as claimed in claim 2, wherein the at least one discharge terminal includes a wedge-shaped cross section.
